(19) United States
(12) Patent Application Publication
(10) Pub. No.: US 2006/0281854 A1
(43) Pub. Date: Dec. 14, 2006

(54) Cissing inhibitor for cationic electrodeposition coating composition and coating composition containing the same

(76) Inventors: Tsuyoshi Imamura, Osaka (JP); Yuki Fujimura, Osaka (JP); Toshiaki Indou, Aichi (JP); Motoi Tanimoto, Osaka (JP); Kanji Takahashi, Aichi (JP)

Correspondence Address: WENDEROTH, LIND & PONACK, L.L.P., 2033 K STREET N. W., SUITE 800, WASHINGTON, DC, 20006-1021, US

(21) Appl. No.: 11/449,747

(22) Filed: Jun. 9, 2006

(30) Foreign Application Priority Data
Jun. 10, 2005 (JP) 2005-171286

(51) Int. Cl. C08L 31/00

(52) U.S. Cl. 524/556

(57) ABSTRACT

Disclosed is an acrylic copolymer type of cissing inhibitor effective in restraining both of self-cissing and oil cissing. The cissing inhibitor for the cationic electrodeposition coating compositions is a polymer having a number-average molecular weight of 1000 to 50000 obtained by polymerizing a monomer mixture containing (A) a polymerizable unsaturated group-containing monomer having a chain hydrocarbon group with a carbon number of 6 or more and (B) a polymerizable unsaturated group-containing monomer having an amino group, characterized in that the amount of the polymerizable unsaturated group-containing monomer (A) occupied in the above-mentioned monomer mixture is 20% by mass or more, the total amount of the above-mentioned polymerizable unsaturated group-containing monomer (A) and polymerizable unsaturated group-containing monomer (B) is 40% by mass or more and the amount of the above-mentioned polymerizable unsaturated group-containing monomer (B) is larger than that of the above-mentioned polymerizable unsaturated group-containing monomer (A).

### TECHNICAL FIELD

The present invention relates to an addition agent for inhibiting cissing from occurring by adding to cationic electrodeposition coating compositions.

### BACKGROUND OF THE INVENTION

Coating films obtained by coating with cationic electrodeposition coating compositions have been utilized so widely and industrially as to be typified by prime coating of automotive bodies by reason of exhibiting high rust prevention. When these uncured films obtained by electrodepositing cationic electrodeposition coating compositions are cured by baking, the volatilization of volatile components existing in the uncured films occasionally causes coating film defects such as pinholes or craters, which are called self-cissing. On the other hand, the adhesion of oil drops scattered from the surroundings during baking to coating film surface occasionally causes failure such as the occurrence of a multitude of craters, which are called oil cissing in contrast with the above self-cissing.

It is known that the above-mentioned self-cissing can be solved by decreasing surface tension. The decrease of surface tension, however, causes a new problem of causing the decrease of adherence to finish coating films. In order to solve this problem, a cationic electrodeposition coating composition containing as a cissing inhibitor an acrylic copolymer obtained by having as essential components a hydroxyl group-containing acrylic monomer, an amino group-containing acrylic monomer and an ether group having no hydroxyl groups-containing acrylic monomer is disclosed in Japanese Unexamined Patent Publication No. 10-110125.

This cissing inhibitor, however, is effective against self-cissing and still can not sufficiently restrain oil cissing. In order to compensate for this fault, the addition of crosslinked resin particles improves oil cissing and yet brings the deterioration of external appearance of coating films.

### DETAILED DESCRIPTION OF THE INVENTION

The object of the present invention is to obtain an acrylic copolymer type of cissing inhibitor effective in restraining both of self-cissing and oil cissing.

A cissing inhibitor for the cationic electrodeposition coating compositions of the present invention is a polymer having a number-average molecular weight of 1000 to 50000 obtained by polymerizing a monomer mixture containing (A) a polymerizable unsaturated group-containing monomer having a chain hydrocarbon group with a carbon number of 6 or more and (B) a polymerizable unsaturated group-containing monomer having an amino group, characterized in that the amount of the monomer (A) occupied in the above-mentioned monomer mixture is 20% by mass or more, the total amount of the above-mentioned monomer (A) and monomer (B) is 40% by mass or more and the amount of the above-mentioned monomer (B) is larger than that of the above-mentioned monomer (A). Here, a carbon number of the chain hydrocarbon group in the above-mentioned monomer (A) may be 18 or less.

The cationic electrodeposition coating composition of the present invention contains the cissing inhibitor described above at a rate of 0.1 to 30% by mass in solid content ratio with respect to a binder component.

A cissing inhibitor for the cationic electrodeposition coating compositions of the present invention can restrain not merely self-cissing but also oil cissing by reason of containing (A) a polymerizable unsaturated group-containing monomer having a chain hydrocarbon group with a carbon number of 6 or more and (B) a polymerizable unsaturated group-containing monomer having an amino group at a specific ratio. That is, it is conceived that the inclusion of the monomer (A) having long chain at a certain rate or more allows both of self-cissing and oil cissing to be restrained, and that the inclusion of the monomer (B) having an amino group larger than the above-mentioned monomer (A) having long chain retains favorable adherence to finish coating. A cissing inhibitor for the cationic electrodeposition coating compositions of the present invention can be utilized for a wide range of coating compositions by reason of developing effect without limiting resin kinds if they are cationic electrodeposition coating compositions.

A cissing inhibitor for the cationic electrodeposition coating compositions of the present invention is obtained by polymerizing a monomer mixture, which contains (A) a polymerizable unsaturated group-containing monomer having a chain hydrocarbon group with a carbon number of 6 or more and (B) a polymerizable unsaturated group-containing monomer having an amino group.

It is conceived that the above-mentioned polymerizable unsaturated group-containing monomer (A) having a chain hydrocarbon group with a carbon number of 6 or more contributes to the decrease of surface free energy of obtained coating films and restrains both of self-cissing and oil cissing.

The above-mentioned chain hydrocarbon group with a carbon number of 6 or more contained in the polymerizable unsaturated group-containing monomer (A) may be linear or branched. The upper limit of a carbon number of the above-mentioned chain hydrocarbon group is preferably 18. Examples of the chain hydrocarbon group with a carbon number of 6 or more include a hexyl group, an ethylhexyl group, an octyl group, a nonyl group, a dodecyl group and a stearyl group.

Specific examples of the above-mentioned polymerizable unsaturated group-containing monomer (A) include hexyl (meth)acrylate, ethylhexyl (meth)acrylate, octyl (meth)acrylate, nonyl (meth)acrylate, dodecyl (meth)acrylate and stearyl (meth)acrylate. In the specification, (meth)acrylate signifies both of methacrylate and acrylate.

The content of the above-mentioned polymerizable unsaturated group-containing monomer (A) in the above-mentioned monomer mixture is 20% by mass or more. The content of less than 20% by mass brings the possibility of being incapable of restraining cissing. The upper limit value of the above-mentioned content is preferably 50% by mass. In the case where the above-mentioned polymerizable unsaturated group-containing monomer (A) is of two kinds or more, the amount of the above-mentioned polymerizable unsaturated group-containing monomer (A) is the total thereof.

On the other hand, it is conceived that the polymerizable unsaturated group-containing monomer (B) having an amino group performs the function of allowing adherence to finish coating without increasing surface free energy decreased by the above polymerizable unsaturated group-containing monomer (A). Specific examples of the above-mentioned polymerizable unsaturated group-containing monomer (B) include dimethylaminoethyl (meth)acrylate, dimethylaminopropyl (meth)acrylate, diethylaminoethyl (meth)acrylate and diethylaminopropyl (meth)acrylate.

The content of the above-mentioned polymerizable unsaturated group-containing monomer (B) in the above-mentioned monomer mixture is set so that the total amount of the above-mentioned polymerizable unsaturated group-containing monomer (A) and polymerizable unsaturated group-containing monomer (B) is 40% by mass or more and the amount of the above-mentioned polymerizable unsaturated group-containing monomer (B) is larger than that of the above-mentioned polymerizable unsaturated group-containing monomer (A). The case of not meeting these conditions causes compatibility between restraint of cissing and adherence to finish coating to become difficult.

The monomer mixture used for obtaining a cissing inhibitor for the cationic electrodeposition coating compositions of the present invention may typically contain other monomers in addition to the above-mentioned polymerizable unsaturated group-containing monomer (A) and polymerizable unsaturated group-containing monomer (B). The above-mentioned other monomers are generally polymerizable unsaturated group-containing monomers having no polar groups. Examples of such monomers include methyl (meth)acrylate, ethyl (meth)acrylate, n-propyl (meth)acrylate, isopropyl (meth)acrylate, n-butyl (meth)acrylate, isobutyl (meth)acrylate, cyclohexyl (meth)acrylate, styrene, vinyltoluene, α-methyl styrene and vinyl acetate.

The use of polymerizable unsaturated group-containing monomers having polar groups except an amino group as the above-mentioned other monomers allows adherence to finish coating to be improved. Examples of the above-mentioned polar groups except an amino group include a hydroxyl group, a carboxyl group, an ether group having no hydroxyl groups, a nitrile group and an amide group. Examples of the above-mentioned polymerizable unsaturated group-containing monomers having a hydroxyl group include hydroxyethyl (meth)acrylate, hydroxypropyl (meth)acrylate, hydroxyhexyl (meth)acrylate, hydroxybutyl (meth)acrylate and ε-caprolactone adduct of hydroxyalkyl mono(meth)acrylate, examples of the polymerizable unsaturated group-containing monomers having a carboxyl group include acrylic acid and methacrylic acid, examples of the polymerizable unsaturated group-containing monomers having an ether group having no hydroxyl groups include methoxyethyl (meth )acrylate, methoxybutyl (meth)acrylate, tetrahydrofurfuryl (meth)acrylate, ethoxyethyl (meth)acrylate, propoxyethyl (meth)acrylate, hexylbutyloxyethyl (meth)acrylate, 2-ethylhexyloxybutyl (meth)acrylate and furfuryl (meth)acrylate, examples of the polymerizable unsaturated group-containing monomers having a nitrile group include (meth)acrylonitrile, and examples of the polymerizable unsaturated group-containing monomers having an amide group include (meth)acrylamide, hydroxyethyl (meth)acrylamide and hydroxypropyl (meth)acrylamide.

However, the use of the above-mentioned polymerizable unsaturated group-containing monomers having polar groups except an amino group brings the possibility of decreasing the effect of restraining cissing. Thus, the above-mentioned polymerizable unsaturated group-containing monomers having polar groups except an amino group are preferably used in a range of not deteriorating effect of the present invention, for example, 5% by mass or less in the monomer mixture.

A cissing inhibitor for the cationic electrodeposition coating compositions of the present invention can be obtained by polymerizing the above-mentioned monomer mixture. The polymerization is performed by generally well-known solution polymerization. Examples of a polymerization initiator to be used for the polymerization include organic peroxides such as benzoyl peroxide, tert-butyl perbenzoate, tert-butyl hydroperoxide, di-tert-butyl peroxide and tert-butyl peroctoate, or azo compounds such as azobisisobutyronitrile and azoisobutyric acid nitrile. The polymerization initiator may be used in one kind or a proper combination of two kinds or more. The added amount of the polymerization initiator is preferably 0.1 to 15% by mass with respect to the monomer mixture. The use of organic peroxides as the polymerization initiator occasionally causes an obtained cissing inhibitor for cationic electrodeposition coating compositions to have acid value, for example, which in this case is 50 or less in solid content.

Examples of a solvent to be used for the polymerization include aromatic hydrocarbons such as toluene and xylene, ketones such as methyl isobutyl ketone, cyclohexanone and isophorone, esters such as ethyl acetate and butyl acetate, and alcohols such as n-butanol, ethylcellosolve, butylcellosolve, methoxypropanol and diethylene glycol monobutyl ether. The above-mentioned solvent may be used in one kind as well as the form of a mixed solvent in which plural kinds are combined.

The reaction temperature of the above-mentioned polymerization is preferably 50 to 170° C., more preferably 80 to 150° C.

The number-average molecular weight of a cissing inhibitor for the cationic electrodeposition coating compositions of the present invention is 1000 to 50000. A number-average molecular weight of less than 1000 brings insufficient effect of restraining cissing, while a number-average molecular weight of more than 50000 brings the possibility of deteriorating smoothness of coating film surface. The adjustment of the above-mentioned molecular weight can be performed by the polymerization conditions and also using chain transfer agents such as dodecyl mercaptan and 2-ethylhexyl thioglycolate.

A cissing inhibitor for the cationic electrodeposition coating compositions of the present invention is typically in a state of being dissolved in a solvent used for the above-mentioned polymerization, and solid content thereof is preferably 5 to 80% by mass. Solid content out of this range brings the possibility of causing the handling to become difficult.

The cationic electrodeposition coating composition of the present invention contains the above cissing inhibitor at a rate of 0.1 to 30% by mass, preferably 1 to 10% by mass, in solid content ratio with respect to a binder component. The above-mentioned binder component comprises substrate resin having cationic groups and a curing agent used for curing this resin. General examples of the above-mentioned substrate resin having cationic groups include epoxy modified substrate resin, acrylic modified substrate resin and both of them, which substrate resin is not particularly prescribed if electrodepositable.

The above-mentioned epoxy modified substrate resin having cationic groups is manufactured by opening epoxy rings in epoxy resin as a starting material by reaction with amines such as primary, secondary and tertiary amine acid salt and a mixture of sulfide and acid. “Cationic groups” in the specification signify cations themselves and cations by adding acid thereto. A typical example of starting material resin is polyphenol polyglycidyl ether type epoxy resin as a reaction product of polycyclic phenol compounds such as bisphenol A, bisphenol F, bisphenol S, phenolic novolac and cresol novolac, and epichlorohydrin. Other examples of starting material resin include oxazolidone ring-containing epoxy resin described in Japanese Unexamined Patent Publication No. 5-306327. This epoxy resin is obtained by reaction of a bisurethane compound obtained by blocking a di-isocyanate compound or NCO groups thereof with lower alcohols such as methanol and ethanol, and epichlorohydrin.

The above-mentioned epoxy resin as a starting material can be used through chain extension by bifunctional polyester polyol, polyether polyol, bisphenols, dibasic carboxylic acid and the like before ring opening reaction of epoxy rings by amines and sulfide. Also, the epoxy resin can be used through addition of monohydroxy compounds such as dodecylphenol, cresol, t-butylphenol, nonyl phenol, and monocarboxylic acids such as stearic acid and octylic acid to a part of epoxy rings before ring opening reaction of epoxy rings for the purpose of adjusting molecular weight or amine equivalent weight and improving heat flow properties.

Examples of amines capable of being used for opening epoxy rings to introduce amino groups include primary, secondary or tertiary amine acid salts such as butylamine, octylamine, diethylamine, dibutyl amine, methylbutylamine, monoethanolamine, diethanolamine, N-methylethanolamine, diethylenetriamine, triethylamine acid salt and N,N-dimethylethanolamine acid salt. Ketimine block primary amino group-containing secondary amine such as aminoethyl ethanolamine methyl isobutyl ketimine can also be used. These amines need to be reacted with epoxy rings by 80% or more.

In contrast therewith, examples of sulfide include diethylsulfide, dipropylsulfide, dibutylsulfide, dihexylsulfide, diphenylsulfide, ethylphenylsulfide, tetramethylene sulfide, pentamethylene sulfide, thiodiethanol, thiodipropanol, thiodibutanol, 1-(2-hydroxyethylthio)-2-propanol, 1-(2-hydroxyethylthio)-2-butanol and 1-(2-hydroxyethylthio)-3-butoxy-1-propanol, and examples of acid include formic acid, acetic acid, lactic acid, propionic acid, boric acid, butyric acid, dimethylol propionic acid, hydrochloric acid, sulfuric acid, phosphoric acid, N-acetylglycine, N-acetyl-β-alanine and sulfamic acid.

The number-average molecular weight of the above-mentioned epoxy modified substrate resin is preferably in a range of 600 to 4000. A number-average molecular weight of less than 600 occasionally deteriorates physical properties such as solvent resistance and corrosion resistance of obtained coating films. On the contrary, a number-average molecular weight of more than 4000 occasionally causes not merely the synthesis to become difficult due to difficult viscosity control of resin solution but also the operation handling such as emulsification dispersion of obtained resin to become difficult. In addition, such high viscosity occasionally deteriorates external appearance of coating films notably due to poor flow properties during heating and curing. Amino value or sulfonium value of the above-mentioned epoxy modified substrate resin is preferably 30 to 150, more preferably 45 to 120. Amino value or sulfonium value of less than 30 causes stable emulsion to be obtained with difficulty, while amino value or sulfonium value of more than 150 brings the possibility of causing a problem in electrodeposition coating workability such as coulombic efficiency and redissolution. The unit of “value” in the specification is mgKOH/g.

On the other hand, the above-mentioned acrylic modified substrate resin may be amino group-containing acrylic resin. The above-mentioned amino group-containing acrylic resin can be obtained by copolymerization of the polymerizable unsaturated group-containing monomer having an amino group, the polymerizable unsaturated group-containing monomer having a hydroxyl group and other monomers as described in the above cissing inhibitor.

Instead of the above-mentioned polymerizable unsaturated group-containing monomer having an amino group, a polymerizable unsaturated group-containing monomer having an epoxy group typified by glycidyl (meth)acrylate may be reacted with secondary amine. In this case, the polymerizable unsaturated group-containing monomer having an epoxy group is preferably obtained by a method of copolymerizing the polymerizable unsaturated group-containing monomer having a hydroxyl group and other unsaturated ethylene monomers to react epoxy groups of the obtained copolymer with secondary amine. Examples of secondary amine capable of being used for reacting with the above-mentioned epoxy groups include diethylamine, dibutyl amine, dicyclohexylamine, morpholine, diethanolamine and N-methylethanolamine, particularly preferably amine having a hydroxyl group and a secondary amino group in a molecule. Methyl isobutyl ketone diketiminizate of diethylenetriamine and methyl isobutyl ketone monoketiminizate of 2-(2-aminoethylamino)ethanol can also be used.

The polymerization of the above-mentioned amino group-containing acrylic resin can be performed by an ordinary method such as solution polymerization. The number-average molecular weight of the copolymer is in a range of 1000 to 50000, preferably 2000 to 20000, and the degree of polymerization can also be adjusted by using chain transfer agents such as dodecyl mercaptan and 2-ethylhexyl thioglycolate, depending on the cases.

The addition of a half-blocked di-isocyanate compound to a hydroxyl group also allows the above-mentioned amino group-containing acrylic polymer to have self crosslinking. The above-mentioned half-blocking signifies blocking of one isocyanate group of di-isocyanate with a blocking agent.

The above-mentioned di-isocyanate compound and the above-mentioned blocking agent used for half-blocking are described in the after-mentioned block isocyanate curing agent, and preferable examples of the above-mentioned di-isocyanate compound include alicyclic di-isocyanates such as isophorone diisocyanate, hexamethylene diisocyanate, 4,4′-methylenebis(cyclohexyl isocyanate), 4,4′-diphenylmethane diisocyanate and norbornane diisocyanate. Preferable examples of the above-mentioned blocking agent used for half-blocking include alcohols such as n-butanol, 2-ethylhexanol, ethylene glycol monobutyl ether and cyclohexanol; phenols such as phenol, nitrophenol, cresol and nonyl phenol; oximes such as dimethyl ketoxime, methyl ethyl ketoxime and methyl isobutyl ketoxime; and lactam such as ε-caprolactam.

A curing agent as another binder component in a cationic electrodeposition coating composition of the present invention is generally a block isocyanate curing agent. A melamine curing agent can be used except for the above-mentioned block isocyanate curing agent.

The above-mentioned block isocyanate curing agent is obtained by reacting a polyisocyanate compound having two or more isocyanate groups with a blocking agent which is added to the isocyanate groups of the polyisocyanate compound, and which is stable at normal temperature and capable of reproducing a free isocyanate group by heating to more than dissociation temperature.

Examples of the above-mentioned polyisocyanate compound include alkylene diisocyanates such as trimethylene diisocyanate, trimethylhexamethylene diisocyanate, tetramethylene diisocyanate and hexamethylene diisocyanate; cycloalkylene diisocyanates such as bis(isocyanate methyl)cyclohexane, cyclopentane diisocyanate, cyclohexane diisocyanate and isophorone diisocyanate; aromatic diisocyanates such as tolylene diisocyanate, phenylene diisocyanate, diphenylmethane diisocyanate and diphenyl ether diisocyanate; aryl-aliphatic diisocyanates such as xylylene diisocyanate and diisocyanate diethylbenzene, triisocyanates such as triphenylmethane triisocyanate, triisocyanate benzene and triisocyanate toluene; tetraisocyanate such as diphenyldimethylmethane tetraisocyanate; polymerization polyisocyanate such as dimer or trimer of tolylene diisocyanate; and a terminated isocyanate-containing compound obtained by reacting the above-mentioned various polyisocyanate compounds with low-molecular active hydrogen-containing organic compounds such as ethylene glycol, propylene glycol, diethylene glycol, trimethylolpropane, hydrogenated bisphenol A, hexane triol, glycerin, pentaerythritol, castor oil and triethanolamine.

On the other hand, examples of the above-mentioned blocking agent include phenolic blocking agents such as phenol, cresol, xylenol, chlorophenol and ethyl phenol; lactam blocking agents such as ε-caprolactam, δ-valerolactam, γ-butyrolactam and β-propiolactam; active methylene blocking agents such as ethyl acetoacetate and acetylacetone; alcohol blocking agents such as methanol, ethanol, propanol, butanol, amyl alcohol, ethylene glycol monomethyl ether, ethylene glycol monoethyl ether, ethylene glycol monomethyl ether, propylene glycol monomethyl ether, benzyl alcohol, methyl glycolate, butyl glycolate, diacetone alcohol, methyl lactate and ethyl lactate; oxime blocking agents such as formaldoxime, acetoaldoxime, acetoxime, methyl ethyl ketoxime, diacetylmonoxime and cyclohexane oxime; mercaptan blocking agents such as butyl mercaptan, hexyl mercaptan, tert-butyl mercaptan, thiophenol, methyl thiophenol and ethyl thiophenol; acid amide blocking agents such as acetic acid amide and benzamide; imide blocking agents such as succinimide and maleimide; and imidazole blocking agents such as imidazole and 2-ethylimidazole. When low-temperature curability is required, blocking agents of at least one kind selected from phenolic, lactam and oxime blocking agents are preferably used. The solid content weight ratio of the above-mentioned epoxy modified substrate resin to block isocyanate curing agent is preferably 50/50 to 90/10, more preferably 60/40 to 80/20. The weight ratio out of this range brings the possibility of causing a problem in curability.

A cationic electrodeposition coating composition of the present invention further contains neutralizing acid for water-dispersing the above-mentioned components. Examples of this neutralizing acid include the same as acid used above in a combination with sulfide. The amount of this acid varies with that of amino groups or sulfonium groups in the above-mentioned epoxy modified substrate resin having cationic groups, and is preferred to be an amount for being capable of water-dispersing.

A cationic electrodeposition coating composition of the present invention may contain resin particles used for typically inhibiting cissing in order to further improve the effect of inhibiting cissing. These resin particles are cross-linked or have high glass transition temperature with no cross-linking. In addition, the above-mentioned resin particles preferably contain cationic groups.

In the case of being cross-linked, the above-mentioned resin particles for inhibiting cissing can be obtained, for example, by emulsion polymerization in aqueous medium of unsaturated ethylene monomers and multifunctional monomers having two or more radically polymerizable unsaturated ethylene bonds in a molecule.

Various polymerizable unsaturated group-containing monomers described in the above cissing inhibitor are applied to the above-mentioned unsaturated ethylene monomers, for example, including alkyl esters of acrylic acid or methacrylic acid such as methyl (meth)acrylate, ethyl (meth)acrylate, n-propyl (meth)acrylate, isopropyl (meth)acrylate, n-butyl (meth)acrylate, isobutyl (meth)acrylate, cyclohexyl (meth)acrylate and ethylhexyl (meth)acrylate, and the following copolymerizable therewith, such as styrene, α-methyl styrene, vinyltoluene, tert-butyl styrene, ethylene, propylene, vinyl acetate, vinyl propionate, acrylonitrile, methacrylonitrile and dimethylaminoethyl (meth)acrylate. These monomers are generally used in two kinds or more.

On the other hand, examples of the above-mentioned multifunctional monomers having two or more radically polymerizable unsaturated ethylene groups in a molecule include polymerizable unsaturated monocarboxylate of polyhydric alcohol, polymerizable unsaturated alcohol ester of polybasic acid and aromatic compound substituted with two or more vinyl groups; examples thereof include ethylene glycol diacrylate, ethylene glycol dimethacrylate, triethylene glycol dimethacrylate, tetraethylene glycol dimethacrylate, 1,3-butylene glycol dimethacrylate, trimethylolpropane triacrylate, trimethylolpropane trimethacrylate, 1,4-butanediol diacrylate, neopentylglycol diacrylate, 1,6-hexanediol diacrylate, pentaerythritol diacrylate, pentaerythritol triacrylate, pentaerythritol tetraacrylate, pentaerythritol dimethacrylate, pentaerythritol trimethacrylate, pentaerythritol tetramethacrylate, glycerol dimethacrylate, glycerol diacrylate, glycerol allyloxy dimethacrylate, 1,1,1-trishydroxymethylethane diacrylate, 1,1,1-trishydroxymethylethane triacrylate, 1,1,1-trishydroxymethylethane dimethacrylate, 1,1,1-trishydroxymethylethane trimethacrylate, 1,1,1-trishydroxymethylpropane diacrylate, 1,1,1-trishydroxymethylpropane triacrylate, 1,1,1-trishydroxymethylpropane dimethacrylate, 1,1,1-trishydroxymethylpropane trimethacrylate, diallyl terephthalate, diallyl phthalate and divinylbenzene.

The cross-linked resin particles can be obtained by emulsion polymerization of a monomer mixture in aqueous medium by a publicly known method, which mixture is of the above-mentioned unsaturated ethylene monomers and multifunctional monomers having two or more radically polymerizable unsaturated ethylene bonds in a molecule.

In the above-mentioned emulsion polymerization, nonionic surface-active agents and cationic surface-active agents are generally used as emulsifying agents. Examples of the above-mentioned nonionic surface-active agents include polyethylene glycol alkyl phenyl ether, polyethylene glycol alkyl ether, polyoxyalkylene alkyl ether, polyethylene glycol sorbitan monostearate and polypropylene glycol polyethylene glycol ether. On the other hand, examples of the cationic surface-active agents include lauryltrimethylammonium chloride, distearyldimethylammonium chloride and alkylpicolinium chloride. Here, the resin particles can contain cationic groups by using as the above-mentioned emulsifying agents a cationic polymer generally used as a pigment dispersant for preparing pigment dispersion paste and a cationic electrodeposition coating composition. Specific examples of a cationic polymer include the epoxy modified substrate resin having cationic groups, which has quaternary ammonium groups and/or tertiary sulfonium groups.

The above-mentioned emulsion polymerization is performed by dissolving or dispersing the emulsifying agents in aqueous medium to drop the above-mentioned monomer mixture thereinto. The mass ratio of the above-mentioned monomer mixture to the above-mentioned emulsifying agents can be adjusted, for example, so as to be 30/70 to 97/3.

The average particle diameter of the cross-linked resin particles thus obtained is preferably 0.01 to 1.0 μm, more preferably 0.02 to 0.5 μm, further more preferably 0.05 to 0.2 μm. An average particle diameter of less than 0.01 μm does not sufficiently allow the intended effect of restraining cissing, while an average particle diameter of more than 1.0 μm decreases stability of the resin particles and brings poor external appearance of coating films.

In the case of having high glass transition temperature with no cross-linking, the resin particles for inhibiting cissing can be obtained in conformance with the above-mentioned manufacturing method of the cross-linked resin particles. That is, it is preferred to use a monomer mixture having high glass transition temperature and not containing the above-mentioned multifunctional monomers. Here, high glass transition temperature signifies 80° C. or more. The above-mentioned glass transition temperature can be obtained by calculating characteristic values of monomers used for obtaining the polymer on the basis of the ratio of each of the monomers.

The content of the above-mentioned resin particles for inhibiting cissing is not particularly limited in the case of not being cross-linked, and is preferably 1 to 10%, more preferably 2 to 5%, in solid content mass ratio with respect to a binder component in coating compositions in the case of being cross-linked resin particles. An added amount of less than 1% brings the possibility of no effect of addition to be observed, while an added amount of more than 10% brings the possibility of causing deterioration in external appearance of coating films.

A cationic electrodeposition coating composition of the present invention may further contain inorganic pigment and pigment dispersion resin. The above-mentioned pigment is not particularly limited if typically used inorganic pigment, for example, including coloring pigments such as titanium dioxide, carbon black and colcothar, inorganic extender pigments such as kaolin, talc, aluminum silicate, calcium carbonate, mica, clay and silica, and inorganic rust preventive pigments such as zinc phosphate, ferric phosphate, aluminum phosphate, calcium phosphate, zinc phosphite, zinc cyanide, zinc oxide, aluminum tripolyphosphate, zinc molybdate, aluminum molybdate, calcium molybdate and aluminum molybdophosphate. Recently, pigments containing lead have not used generally in consideration of influence on the environment; however, it is needless to say that pigments containing lead can be used.

General examples of the above-mentioned pigment dispersion resin include cationic or nonionic low-molecular-weight surface-active agents, and modified epoxy resin having quaternary ammonium groups and/or tertiary sulfonium groups.

The above-mentioned pigment dispersion resin and inorganic pigment are mixed by predetermined amounts and thereafter dispersed by using ordinary dispersing devices such as ball mill and sand grind mill until the particle diameter of pigment in the mixture becomes a predetermined uniform particle diameter to thereby obtain pigment dispersion paste. This pigment dispersion paste can be used by an amount of 0 to 50% by mass as solid content of pigment in a cationic electrodeposition coating composition.

Also, organic pigment having specified specific gravity and average particle diameter is contained instead without containing the above-mentioned inorganic extender pigments, and pigment-containing resin particles can be used instead on the conditions that the amount of pigment typically used is 5.0% by mass or less with respect to coating composition solid content in order to improve redispersibility.

In the case of the former, organic pigment having a specific gravity of 0.9 to 3.0, preferably 0.9 to 2.2, is used. A specific gravity of more than 3.0 brings the possibility of decreasing pigment settling stability. The average particle diameter of the above-mentioned organic pigment is 10 to 700 nm, preferably 10 to 200 nm. An average particle diameter of more than 700 nm brings the possibility of deteriorating pigment aggregability and settling stability.

Average particle diameter is used for generally denoting granularity of particles (particles are coarse or fine), for which diameter the following are used: median diameter, arithmetic average diameter, surface area average diameter and volume area average diameter equivalent to 50% of mass. The average particle diameter of resin fine particles used for the present invention denotes median diameter measured by laser diffraction scattering type particle-size distribution measuring device.

Examples of the above-mentioned organic pigment include red or orange organic pigments such as β-naphthols, naphthols AS, pyralozones, benzimidazolos, watching red, permanent red 2B, lake red R, Bordeaux 10B, BON maroon medium, BON maroon light, thioindigos, anthraquinones, perylenes, perinones, quinacridons and diketopyrrolopyrroles, yellow organic pigments such as first yellow, benzimidazolo yellow, disazos, polyazos, isoindolinones, isoindolins, anthraquinones, quinophthalones, azo, azomethine and a compound comprising organic coloring matter having nitroso groups and metal ions, green organic pigment such as phthalocyanine green, blue organic pigments such as phthalocyanine blue, indanthrene blue and indanthrone blue, and violet organic pigments such as dioxazine violet and quinacridone violet.

The concentration of the above-mentioned organic pigment in coating composition solid content of a cationic electrodeposition coating composition is 1 to 20% by mass, preferably 1 to 5% by mass. A pigment concentration of less than 1% by mass decreases hiding power. A pigment concentration of more than 20% by mass brings the possibility of deteriorating external appearance of coating films to cause surface roughening.

Here, with the object of improving hiding properties of coated matters, inorganic coloring pigment such as carbon black may be used together with organic coloring pigment. Inorganic coloring pigment such as carbon black added to a coating composition as a coloring agent is not inorganic extender pigment added as an extending agent, but may be included in a coating composition of the present invention. However, inorganic coloring pigment having a specific gravity of 0.9 to 3.0 and an average particle diameter of 10 to 700 nm similarly to organic pigment needs to be used in the case of being included therein. The use of inorganic coloring pigment out of this range does not allow favorable pigment settling stability and redispersibility.

In this case, the above-mentioned extender pigments such as kaolin, talc, aluminum silicate, calcium carbonate, mica, clay and barium sulfate are not included. That is, inorganic extender pigments are not substantially included. Inorganic extender pigments described herein signify inorganic pigments added to a coating composition as an extending agent. Generally, inorganic extender pigments have a specific gravity of 2.5 to 4.5 and an average particle diameter of 500 to 100000 nm. A cationic electrodeposition coating composition obtained in this manner contains organic pigment and does not contain any inorganic extender pigment, so that resin adsorptivity of the pigment contained in the coating composition becomes high. Thus, the pigment dispersed in the coating composition is aggregated with difficulty, leading to superior pigment dispersibility and redispersibility.

On the other hand, pigment-containing resin particles used for the case of the latter have structure such that a pigment component is contained by a resin component. These pigment-containing resin particles can have so-called core shell structure. That is, a pigment component and a resin component correspond to a core portion and a shell portion respectively, which is structure such that a pigment component is contained in resin particles. With regard to the above-mentioned pigment-containing resin particles, all of the contained pigment component does not need to be covered with the resin component, which resin particles may be in a state such that a part of the pigment is not covered therewith, that is to say, may not have core shell structure as described above. The above-mentioned pigment-containing resin particles have the decreased aggregability of the pigment, and are preferred to be covered in a degree such that redispersion is easily performed in the case of being settled and thereafter stirred again.

In the above-mentioned pigment-containing resin particles, the contained pigment component is not particularly limited, for example, including inorganic pigments such as titanium oxide, carbon black, colcothar, kaolin, talc, clay, silicon dioxide, aluminum silicate, calcium carbonate, zinc phosphate, ferric phosphate, aluminum phosphate, calcium phosphate, zinc phosphite, zinc cyanide, zinc oxide, aluminum tripolyphosphate, zinc molybdate, aluminum molybdate, calcium molybdate, aluminum molybdophosphate and aluminum zinc molybdophosphate. In addition, organic pigment can be used. These pigment components may be of only one kind or a mixture of two kinds or more.

The pigment-containing resin particles in which titanium oxide, carbon black and the like are contained as the pigment component are preferably used in the present invention. The reason therefor is that these pigment components have so high hiding power as to be particularly appropriate for uses of the present invention.

Examples of a resin component containing the above-mentioned pigment component include urethane resin, acrylic resin (also including acrylic copolymer resin), vinyl resin, olefin resin and aromatic resin. Among these, urethane resin or acrylic resin is preferable. The reason therefor is that an electrodeposition coating composition containing the pigment-containing resin particles employing these as a resin component is superior in physical strength, external appearance of coating films or the like.

These pigment-containing resin particles can be prepared by the following method, for example, in the case where a resin component is urethane resin. That is to say, dispersion liquid in which pigment is previously dispersed in low-viscosity organic solvent is prepared, and polyol resin and polyhydric isocyanate compound and/or urethane prepolymer are mixed into this dispersion liquid, and then the obtained liquid mixture is mixed and dispersed by emulsification into aqueous or paraffinic solvent to which emulsifying agent and protective colloid are added singly or together. Such a preparation method is an example of manufacturing methods of the pigment-containing resin particles. The above-mentioned preparation method is a publicly known preparation method described in Japanese Unexamined Patent Publication No. 5-230225 and the like.

The average particle diameter of the above-mentioned pigment-containing resin particles preferably has a lower limit of 0.1 μm and an upper limit of 10.0 μm. The above-mentioned lower limit is more preferably 1.0 μm, and the above-mentioned upper limit is more preferably 6.0 μm. The use of the pigment-containing resin particles having an average particle diameter in the above-mentioned range allows smoothness of the obtained electrodeposition coating films to become higher.

The above-mentioned pigment-containing resin particles may be colored resin particles. For example, the use of resin particles colored by using dyestuffs allows an electrodeposition coating composition having higher hiding power to be prepared. “Colored” described herein is not the meaning in a narrow sense, of having chromatic color, but also includes the meaning of having achromatic color with low brightness. Accordingly, also gray or black pigment-containing resin particles are included in “colored resin particles” described herein.

The specific gravity of the above-mentioned pigment-containing resin particles is preferably in a range of 0.95 to 1.2. A specific gravity of more than 1.2 brings the possibility of decreasing redispersibility of the resin particles due to storage after the pigment-containing resin particles are settled. A specific gravity of less than 0.95 brings the possibility that the pigment-containing resin particles float on a coating material surface in an electrodeposition bath.

The use of the pigment-containing resin particles as described above allows an electrodeposition coating composition having high redispersibility to be prepared. These pigment-containing resin particles tend to be oriented to a coating material surface in an electrodeposition coating film as compared with generally used inorganic pigment for the reason that a surface of the particles is contained by a resin component. The orientation of a resin component to a coating material surface greatly affects gloss value of a coating film. Thus, the use of such pigment-containing resin particles allows gloss value of a coating film to be optionally adjusted without deteriorating surface-roughness of a coating film, in other words, while retaining smoothness of a coating film.

Incidentally, pigment contained in an electrodeposition coating composition is generally prepared for a pasty state (pigment dispersion paste) by previously dispersing in aqueous medium at high concentration, and then added to the composition in a pasty state. The reason therefor is that this facilitates the dispersion of pigment in the electrodeposition coating composition in a low-concentration uniform state. However, pigment-containing resin particles of the present invention are already covered with resin, so that the process of preparing for a pasty state can be omitted. In the case where pigment-containing resin particles are already in the form of emulsion dispersed in solvent, this emulsion can directly be added to the electrodeposition coating composition. This allows the advantage such that the processes in preparing the electrodeposition coating composition are so decreased that the preparation becomes easy.

The above-mentioned pigment-containing resin particles may be added after being prepared for dispersion paste as required. This dispersion paste can be prepared in the same manner as pigment dispersion paste described below.

Preferable examples of the above-mentioned pigment-containing resin particles include RUBCOULEUR (manufactured by Dainichiseika Color & Chemicals Mfg. Co., Ltd.), ARTPEARL (manufactured by Negami Chemical Industrial Co., Ltd.) and BURNOCK (manufactured by Dainippon Ink and Chemicals, Incorporated).

The above-mentioned pigment-containing resin particles are preferably contained in a range of 2.0 to 50.0% by mass solid content with respect to coating material solid content of an electrodeposition coating composition. A content of the pigment-containing resin particles less than 2.0% by mass solid content brings the possibility of being incapable of securing sufficient hiding power, while a content of more than 50.0% by mass solid content brings the possibility of deteriorating external appearance of coating films or coating film performance.

In addition thereto, a cationic electrodeposition coating composition of the present invention may contain common addition agents for coating compositions such as a surface-active agent, an antioxidant, an ultraviolet absorbing agent and a curing accelerator.

A cationic electrodeposition coating composition of the present invention can be obtained by mixing the above-mentioned substrate resin having cationic groups, curing agent, as required, pigment dispersion paste and addition agents for coating compositions to add cissing inhibitor, resin particles and addition agents to the system in an optional stage.

A cationic electrodeposition coating composition of the present invention is subject to cationic electrodeposition coating on a substrate. Electrodeposition coating itself can be performed in accordance with a known method, generally, on the conditions of typically adjusting an electrodeposition bath, which accommodates the above-mentioned cationic electrodeposition coating composition having a solid content concentration set at 5 to 40% by weight, preferably 15 to 25% by weight, and pH adjusted within a range of 5.5 to 8.5 by diluting with deionized water, to a bath temperature of 20 to 35° C. at a load voltage of 100 to 450 V.

The film thickness of electrodeposition coating is appropriately in a range of 5 to 40 μm, preferably 10 to 30 μm, in dry film thickness, and the above-mentioned conditions of electrodeposition coating are preferably set so as to be this film thickness. The baking of coating films is appropriately performed generally at a temperature of 100 to 220° C., preferably 140 to 200° C., in a time range of 10 to 30 minutes.

With regard to cationic electrodeposition coating films of the present invention thus formed, top coating films can be formed after intermediate coating films are formed thereon as required. Coating compositions and coating conditions used for surface coating of automobiles and the like can apply to the above-mentioned formation of intermediate coating films and finish coating films.

### EXAMPLES

The present invention will be illustrated by the following examples which, however, are not construed as limiting the present invention.

### Example 1

Production of a Cissing Inhibitor for Cationic Electrodeposition Coating Compositions No. 1

77.6 parts of methyl isobutyl ketone was charged into a reaction vessel provided with a stirrer, a thermometer, a decanter, a reflux condenser, a nitrogen inlet tube and a dropping funnel, and heated up to a temperature of 115° C. while introducing nitrogen gas, and a mixture of 20 parts of ethylhexyl acrylate as (A) a polymerizable unsaturated group-containing monomer having a chain hydrocarbon group with a carbon number of 6 or more and 30 parts of n-butyl methacrylate as another monomer was dropped thereinto with uniform velocity for 3 hours. Simultaneously with this dropping, 50 parts of dimethylaminoethyl methacrylate as (B) a polymerizable unsaturated group-containing monomer having an amino group and a mixed solution of 5 parts of tert-butyl peroxyhexyl and 15.5 parts of methyl isobutyl ketone were dropped thereinto with uniform velocity for 3.5 hours and 4.5 hours, respectively. After finishing all of the droppings, the stirring was continued for 2 hours to finish polymerization reaction. With regard to the obtained cissing inhibitor A for cationic electrodeposition coating compositions, solid content concentration was 50% by mass, acid value was 20.5 and number-average molecular weight was 1800.

Production of a Cissing Inhibitor for Cationic Electrodeposition Coating Compositions No. 2 to 5

In the above-mentioned production No. 1, cissing inhibitors B to E for cationic electrodeposition coating compositions were obtained in the same manner except for modifying (A) a polymerizable unsaturated group-containing monomer having a chain hydrocarbon group with a carbon number of 6 or more, (B) a polymerizable unsaturated group-containing monomer having an amino group and another monomer as shown in Table 1.

Production of a Comparative Cissing Inhibitor for Cationic Electrodeposition Coating Compositions No. 1 to 4

In the above-mentioned production No. 1, comparative cissing inhibitors F to I for cationic electrodeposition coating compositions were obtained in the same manner except for modifying (A) a polymerizable unsaturated group-containing monomer having a chain hydrocarbon group with a carbon number of 6 or more, (B) a polymerizable unsaturated group-containing monomer having an amino group and another monomer as shown in Table 1.

Production of a Comparative Cissing Inhibitor for Cationic Electrodeposition Coating Compositions No. 5 (Production Example 1 of Japanese Unexamined Patent Publication No. 10-110124)

1500 parts of butylcellosolve was charged into a reaction vessel provided with a stirrer, a thermometer, a decanter, a reflux condenser, a nitrogen inlet tube and a dropping funnel, and heated up to a temperature of 120° C. while introducing nitrogen gas, and a mixture of 627 parts of methyl methacrylate, 191 parts of lauryl methacrylate, 182 parts of hydroxybutyl acrylate, 300 parts of 2-methoxyethyl acrylate, 200 parts of dimethylaminoethyl methacrylate and 50 parts of tert-butyl peroxy-2-ethyl hexanoate was dropped thereinto with uniform velocity over 3 hours. After finishing the dropping, the reaction was further performed at a temperature of 120° C. for 3 hours and cooled to obtain a comparative cissing inhibitor J for cationic electrodeposition coating compositions. With regard to the obtained resin, solid content concentration was 50% by mass and number-average molecular weight was 10000.

Production of Resin Particles for Inhibiting Cissing

222.0 parts of isophorone diisocyanate (hereinafter abbreviated as IPDI) was put in a reaction vessel provided with a stirring apparatus, a condenser tube, a nitrogen inlet tube and a thermometer, and diluted with 39.1 parts of methyl isobutyl ketone (hereinafter abbreviated as MIBK), and thereafter 0.2 part of dibutyltin dilaurate was added thereto. Thereafter, the mixture was heated up to a temperature of 50° C., and thereafter 131.5 parts of 2-ethylhexanol (hereinafter abbreviated as 2EH) was dropped thereinto under stirring in a dry atmosphere over 2 hours. The reaction temperature was maintained at 50° C. by properly cooling. As a result, 2-ethylhexanol half-blocked IPDI (resin solid content of 90.0%) was obtained.

382.2 parts of bisphenol A type epoxy resin having an epoxy equivalent weight of 188 (manufactured by Dow Chemical Company) and 117.8 parts of bisphenol A were charged into another reaction vessel and reacted under a nitrogen atmosphere at a temperature of 150 to 160° C. for 1 hour, and cooled to a temperature of 120° C., and thereafter 209.8 parts of the prepared 2-ethylhexanol half-blocked IPDI (MIBK solution) was added thereto. The mixture was reacted at a temperature of 140 to 150° C. for 1 hour, and thereafter 205.0 parts of 6 mol-ethyleneoxide adduct of bisphenol A was added thereto and cooled to a temperature of 60 to 65° C.

408.0 parts of 1-(2-hydroxyethylthio)-2-propanol, 144.0 parts of deionized water and 134 parts of dimethylol propionic acid were added thereto and reacted at a temperature of 65 to 75° C. until acid value became 1 to finish tertiarization by introducing tertiary sulfonium groups to the epoxy resin and adding 1595.2 parts of deionized water, and thereby obtain tertiary sulfonium group-containing epoxy resin (resin solid content of 30% by mass).

9.25 parts of tertiary sulfonium group-containing epoxy resin thus obtained and 80 parts of deionized water were charged and heated up to a temperature of 75° C. 20.73 parts of initiator liquid comprising 0.5 part of 2,2′-azobis-N,N′-dimethyl isobutyl amidine, 0.23 part of glacial acetic acid and 20 parts of deionized water were added thereto.

Subsequently, 10 parts of methyl methacrylate was dropped thereinto over 5 minutes to further drop over 40 minutes a solution in which 90 parts of monomer liquid comprising 12 parts of styrene, 10 parts of n-butyl acrylate, 52.5 parts of methyl methacrylate, 2 parts of glycidyl methacrylate, 3.5 parts of FM-1 (hydroxyl group-containing monomer manufactured by DAICEL CHEMICAL INDUSTRIES, LTD.) and 10 parts of neopentylglycol dimethacrylate was added to 27.75 parts of the above tertiary sulfonium group-containing epoxy resin and 70.88 parts of deionized water, and thereafter finish the reaction by continuing stirring for 1 hour.

With regard to the obtained cross-linked resin particles, average particle diameter was 78 nm and solid content concentration was 36% by mass.

Production of Pigment Dispersion Resin

222 parts of IPDI, 391 parts of MIBK and 0.2 part of dibutyltin laurate were compounded into a five-necked flask mounted with a reflux condenser, a stirrer and a dropping funnel, and 99 parts of furfuryl alcohol was added thereto through the dropping funnel while stirred under a dry nitrogen atmosphere and watching so that the temperature of the reaction mixture did not exceed 55° C. After finishing the dropping, the reaction mixture was hot-mixed at a temperature of 60° C. for 1 hour to obtain furfuryl alcohol half-blocked IPDI having a solid content concentration of 90%.

On the other hand, aside from the above, 385.3 parts of DER331J (manufactured by Dow Chemical Company, bisphenol A type epoxy resin, an epoxy equivalent weight of 188), 119.7 parts of bisphenol A and 28.8 parts of 2-ethyl hexoic acid were compounded into a five-necked flask mounted with a reflux condenser, a stirrer and a dropping funnel, and heated up to a temperature of 150° C. under a nitrogen atmosphere while stirred. 0.45 part of dimethylbenzylamine was added to the reaction mixture, which generated heat and was retained by heating at a temperature of 170° C. for approximately 1 hour and a half while stirred. The reaction mixture was cooled to a temperature of 130° C. and thereafter stirred vigorously, and 198.4 parts of furfuryl alcohol half-blocked IPDI obtained in the above was dropped thereinto over 30 minutes through the dropping funnel. After finishing the dropping, the reaction mixture was stirred by heating at the same temperature, and 157.1 parts of butylcellosolve was added thereto and cooled to a temperature of 105° C. or less while stirred. The stirring was stopped to add 276.6 parts of methyl isobutyl diketimine of diethylenetriamine (73%-solution of MIBK) and resume stirring. The reaction mixture generated heat and was stirred by heating at a temperature of 115 to 120° C. for approximately 1 hour. 129.2 parts of butylcellosolve was added to the reaction mixture, which was cooled to a temperature of 95° C. or less. 20.5 parts of ion-exchange water was added thereto to add 77.5 parts of acetic anhydride over 1 hour in a division of four times while stirring by heating at a temperature of 70 to 90° C. After stirring by heating at the same temperature for 1 hour, 164.5 parts of deionized water was added thereto and heated up to a temperature of around 100° C., and then stirred by heating at a temperature of 97 to 110° C. to distill off the MIBK while refluxing at normal pressure. 207.3 parts of butylcellosolve was added thereto and cooled to a temperature of 95° C. or less to thereafter add 1996.3 parts of deionized water while stirring and obtain pigment dispersion resin having a solid content concentration of approximately 25%.

Production of Pigment Dispersion Paste

1025.9 parts of pigment dispersion resin obtained above and 350 parts of deionized water were compounded into a stainless-steel flask and stirred uniformly. Subsequently, 78.3 parts of carbon black, 705.2 parts of kaolin, 71.4 parts of dibutyltin oxide and 84.6 parts of deionized water were compounded thereinto and dispersed by a sand grind mill so that granularity became 15 μm or less to obtain pigment dispersion paste having a total solid content of 48%, a resin solid content of 11.1% and a pigment solid content of 36.9%.

Production of a Block Isocyanate Curing Agent

480.2 parts of IPDI and 78.2 parts of MIBK were compounded into a five-necked flask mounted with a reflux condenser, a stirrer and a dropping funnel, and dissolved uniformly under a dry nitrogen atmosphere. The mixture was heated up to a temperature of 70° C. while stirred to thereafter compound 0.1 part of dibutyltin dilaurate and drop 319.8 parts of furfuryl alcohol through the dropping funnel. The reaction mixture generated heat and was stirred by heating at a temperature of 75 to 85° C. for 30 minutes. The mixture was cooled to a temperature of 65° C. to thereafter drop 121.7 parts of methyl ethyl ketone oxime through the dropping funnel. The reaction mixture generated heat and was stirred by heating at a temperature of 65 to 75° C. for 30 minutes. The disappearance of isocyanate groups was confirmed by IR spectrum to obtain a block isocyanate curing agent having a solid content concentration of 80%.

Production of Epoxy Modified Substrate Resin Having Cationic Groups

1283.6 parts of EPOTOHTO YD-013 BK67 (manufactured by Tohto Kasei Co., Ltd., 67% by mass MIBK solution of bisphenol A type epoxy resin having an epoxy equivalent weight of 860) was compounded into a four-necked flask mounted with a reflux condenser and a stirrer, and heated up to a temperature of approximately 100° C. while stirred. After obtaining a non-volatile component of 80% by MIBK removing process, the mixture was cooled to a temperature of 95° C. or less. The stirring was stopped to compound 58.7 parts of methyl isobutyl diketimine of diethylenetriamine (73%-solution of MIBK), 32.8 parts of methylethanolamine and 42.0 parts of diethanolamine and resume stirring. The reaction mixture generated heat and was retained by heating at a temperature of 110 to 120° C. for 1 hour while stirred to obtain epoxy modified substrate resin having cationic groups with a solid content concentration of approximately 80%.

Production of Acrylic Modified Substrate Resin Having Cationic Groups

41.7 parts of MIBK was compounded into a five-necked flask mounted with a reflux condenser, a dropping funnel and a stirrer, and heated up to a temperature of 115° C. under a nitrogen atmosphere while stirred. The compound liquid comprising 17.5 parts of hydroxyethyl methacrylate, 23.5 parts of n-butyl acrylate, 22.6 parts of styrene, 18.6 parts of methyl methacrylate, 17.8 parts of dimethylaminoethyl methacrylate and 5.3 parts of tert-butyl peroxy-2-ethyl hexanoate was dropped through the dropping funnel over 3 hours, and thereafter stirred by heating at the same temperature for 1 hour. Subsequently, mixed solution containing 0.5 part of MIBK and 0.5 part of tert-butyl peroxy-2-ethyl hexanoate was dropped through the dropping funnel over 30 minutes, and further stirred by heating at the same temperature for 30 minutes to obtain acrylic modified substrate resin having cationic groups with a solid content concentration of approximately 67.5% by mass.

### Example 2

Production of a Cationic Electrodeposition Coating Composition No. 1

512.7 parts of the block isocyanate curing agent, 1196.2 parts of the epoxy modified substrate resin having cationic groups, each being obtained above, and 3 parts in solid content mass ratio of the cissing inhibitor A for cationic electrodeposition coating compositions obtained in Example 1 were mixed and neutralized with 53.7 parts of 50%-lactic acid. Thereafter, deionized water was added thereto and diluted slowly to distill off MIBK under a reduced pressure so as to be a solid content concentration of 36% by mass and then prepare main emulsion.

265.1 parts of the pigment dispersion paste obtained above was mixed into 1004.3 parts of this main emulsion and added deionized water thereto to obtain a cationic electrodeposition coating composition A having a solid content of 20% by mass.

### Example 3

Production of a Cationic Electrodeposition Coating Composition No. 2 to 5

In the above production of a cationic electrodeposition coating composition, cationic electrodeposition coating compositions B to F were obtained in the same manner except for modifying kinds and amount of the cissing inhibitor, and addition of resin particles for inhibiting cissing as shown in Table 2.

Production of a Cationic Electrodeposition Coating Composition No. 6

523.7 parts of the block isocyanate curing agent, 1185.2 parts of the epoxy modified substrate resin having cationic groups and 43.4 parts of the acrylic modified substrate resin having cationic groups, each being obtained above, were mixed and neutralized with 53.7 parts of 50%-lactic acid. Thereafter, deionized water was added thereto and diluted slowly to distill off MIBK under a reduced pressure so as to be a solid content concentration of 36% by mass and then prepare main emulsion.

265.1 parts of the pigment dispersion paste obtained above and 3 parts in solid content mass ratio of the cissing inhibitor A for cationic electrodeposition coating compositions obtained in Example 1 were mixed into 1004.3 parts of this main emulsion and added deionized water thereto to obtain a cationic electrodeposition coating composition G having a solid content of 20% by mass.

Production of a Comparative Cationic Electrodeposition Coating Composition

In the above production of a cationic electrodeposition coating composition, comparative cationic electrodeposition coating compositions H to N were obtained in the same manner except for modifying kinds and amount of the cissing inhibitor, and addition of resin particles for inhibiting cissing as shown in Table 2.

### Example 4

Evaluation of Cationic Electrodeposition Coating Compositions

<Self-Cissing>

A zinc-phosphated steel plate having a surface-roughness of 0.9 to 1.0 μm was electrocoated with the cationic electrodeposition coating compositions A to N obtained above at such a voltage that film thickness after baking becomes 20 μm to perform baking at a temperature of 170° C. for 20 minutes. The surface of the obtained cured coating film was visually observed to count the number of caused cissing and then evaluate in accordance with the following criterion for evaluation.

⊚: no occurrence of cissing is observed and no problems are caused in external appearance

◯: scarce occurrence of cissing is observed and no problems are caused in external appearance

Δ: the occurrence of cissing is observed, but not so as to deteriorate external appearance

x: the occurrence of cissing is so observed as to deteriorate external appearance

<Oil Cissing>

30 ppm of rust preventive machine oil was mixed into the cationic electrodeposition coating compositions A to N obtained above, and continuously stirred for 48 hours. Thereafter, electrocoating and baking were performed in the same manner as the evaluation of self-cissing. The surface of the obtained cured coating film was visually observed to evaluate the state of caused cissing in accordance with the above criterion for evaluation of self-cissing.

<Adhesion Properties>

Electrocoating was performed in the same manner as the above-mentioned evaluation of self-cissing to perform baking at a temperature of 220° C. for 20 minutes. The obtained cured coating film was spray-coated with ORGASELECT 130 manufactured by Nippon Paint Co., Ltd. (alkyd resin finish coating compositions) as finish coating compositions so as to be a dry film thickness of 35 μm to perform baking at a temperature of 140° C. for 30 minutes. 100 pieces of grids having a size of 2 mm×2 mm were made on the obtained coating film in conformance with JIS K5600 to stick a cellophane adhesive tape on a surface thereof and then confirm the number of grid coating films left on the coating surface after abruptly peeling off. Then, a square off which 50% or more of grids were peeled is regarded as peeled off.

◯: the number of grid coating films left=100

x: the number of grid coating films left≦99

<Smoothness>

Surface-roughness (Ra) was measured on a surface of the coating film obtained in the above-mentioned evaluation of self-cissing with a plane roughness meter SJ-201P (manufactured by Mitsutoyo Corporation) by the standard of a cutoff of 0.8 mm and a scanning length of 4 mm. The criterion for evaluation is as follows.

⊚: Ra≦0.2

◯: 0.2<Ra≦0.25

x: Ra>0.25

The above results of evaluating are described together in Table 2.

TABLE 1

| Material monomers | | | | | | | Comparative | | | |
|---|---|---|---|---|---|---|---|---|---|---|
| | Kinds of | Cissing inhibitors | | | | | cissing inhibitors | | | |
| | monomers *¹ | A | B | C | D | E | F | G | H | I |
| Polymerizable unsaturated | EHA | 20 | 10 | 20 | 21 | 15 | 36 | | | 25 |
| group-containing monomer (A) | EHMA | | 19 | | | 10 | | 14 | | 26 |
| Polymerizable unsaturated | | | | | | | | | | |
| group-containing monomer | DMAEMA | 50 | 30 | 35 | 30 | 40 | 10 | 30 | 5 | 25 |
| having an amino group | | | | | | | | | | |
| Other monomers | nBA | 30 | | 10 | | | 54 | 28 | | |
| | ST | | 15 | 15 | | 10 | | | 50 | |
| | nBMA | | 16 | | 39.4 | 10 | | 4.5 | | 10 |
| | MMA | | 10 | | | 10 | | 23.5 | 45 | 7 |
| | TBMA | | | 20 | 9.6 | | | | | 7 |
| | HEMA | | | | | 5 | | | | |

Unit: part
*¹ EHA: ethylhexyl acrylate,
EHMA: ethylhexyl methacrylate
DMAEMA: dimethylaminoethyl methacrylate,
nBA: n-butyl acrylate,
ST: styrene,
nBMA: n-butyl methacrylate,
MMA: methyl methacrylate
TBMA: tert-butyl methacrylate,
HEMA: hydroxyethyl methacrylate

TABLE 2

| | | Cationic electrodeposition coating compositions | | | | | | |
|---|---|---|---|---|---|---|---|---|
| | | A | B | C | D | E | F | G |
| Kinds of main | | Ep | Ep | Ep | Ep | Ep | Ep | Ac + Ep |
| emulsion *¹ | | | | | | | | |
| Cissing inhibitors | | A | B | C | D | E | A | A |
| (amount) | | 3 | 3 | 5 | 5 | 10 | 3 | 3 |
| Amount of resin | | — | — | — | — | — | 3 | 3 |
| particles | | | | | | | | |
| Evalua- | Self-cissing | ⊚ | ⊚ | ⊚ | ⊚ | ⊚ | ⊚ | ⊚ |
| tions | Oil cissing | ◯ | ◯ | ◯ | ◯ | ◯ | ⊚ | ⊚ |
| | Adhesion | ◯ | ◯ | ◯ | ◯ | ◯ | ◯ | ◯ |
| | properties | | | | | | | |
| | Smoothness | ⊚ | ⊚ | ⊚ | ⊚ | ⊚ | ◯ | ◯ |

| | | Comparative cationic electrodeposition coating | | | | | | |
|---|---|---|---|---|---|---|---|---|
| | | compositions | | | | | | |
| | | H | I | J | K | L | M | N |
| Kinds of main | | Ep | Ep | Ep | Ep | Ep | Ep | Ep |
| emulsion *¹ | | | | | | | | |
| Cissing inhibitors | | F | G | H | I | I | I | — |
| (amount) | | 3 | 5 | 5 | 5 | 3 | 3 | 3 |
| Amount of resin | | — | — | — | — | 3 | 7 | 3 |
| particles | | | | | | | | |
| Evalua- | Self-cissing | ⊚ | ◯ | ◯ | ⊚ | ⊚ | ⊚ | Δ |
| tions | Oil cissing | ◯ | X | X | X | Δ | ∘ | Δ |
| | Adhesion | X | ◯ | ◯ | ◯ | ◯ | ◯ | ⊚ |
| | properties | | | | | | | |
| | Smoothness | ⊚ | ⊚ | ⊚ | ⊚ | ∘ | X | ◯ |

*¹ Ep: epoxy modified substrate resin having cationic groups
Ac + Ep: mixture of acrylic modified substrate resin and epoxy modified substrate resin having cationic groups

It could be confirmed that a cissing inhibitor of the present invention allowed the effect of restraining both of self-cissing and oil cissing by being contained in a cationic electrodeposition coating composition. On the other hand, a cissing inhibitor not included in the present invention could not satisfy all evaluation items, for example, deteriorating adhesion properties to finish coating.

Resin particles for inhibiting cissing were further added to a cationic electrodeposition coating composition containing a cissing inhibitor of the present invention, so that oil cissing could be restrained in a high level and smoothness could be controlled to the decrease in a degree of no problems. On the contrary, a cissing inhibitor in prior art allowed the effect of restraining self-cissing and could not restrain oil cissing, though. The addition of resin particles for inhibiting cissing thereto allowed oil cissing to be restrained and decreased smoothness, though.

### INDUSTRIAL APPLICABILITY

A cissing inhibitor of the present invention allowed self-cissing and oil cissing to be restrained and electrodeposition coating films to be obtained without any problems in external appearance by being contained in various cationic electrodeposition coating compositions.

1. A cissing inhibitor for cationic electrodeposition coating compositions being a polymer having a number-average molecular weight of 1000 to 50000 obtained by polymerizing a monomer mixture containing (A) a polymerizable unsaturated group-containing monomer having a chain hydrocarbon group with a carbon number of 6 or more and (B) a polymerizable unsaturated group-containing monomer having an amino group, characterized in that an amount of the monomer (A) occupied in said monomer mixture is 20% by mass or more, a total amount of said monomer (A) and monomer (B) is 40% by mass or more and an amount of said monomer (B) is larger than that of said monomer (A).

2. A cissing inhibitor for cationic electrodeposition coating compositions according to claim 1, wherein a carbon number of the chain hydrocarbon group in said monomer (A) is 18 or less.

3. A cationic electrodeposition coating composition containing a cissing inhibitor according to claim 1 at a rate of 0.1 to 30% by mass in solid content ratio with respect to a binder component.

4. A cationic electrodeposition coating composition containing a cissing inhibitor according to claim 2 at a rate of 0.1 to 30% by mass in solid content ratio with respect to a binder component.
